(19) United States
(12) Patent Application Publication
(10) Pub. No.: US 2017/0368916 A1
(43) Pub. Date: Dec. 28, 2017

(54) METHOD AND SYSTEM FOR PREVENTING VEHICULAR MOLDING AND AVOIDING MOLD SMELL

(71) Applicant: FORD GLOBAL TECHNOLOGIES, LLC, Dearborn, MI (US)

(72) Inventors: Mahmoud Yousef Ghannam, Canton, MI (US); Aed M. Dudar, Canton, MI (US)

(21) Appl. No.: 15/189,756

(22) Filed: Jun. 22, 2016

(51) Int. Cl. B60H 3/00; B60H 1/12; B60H 1/32; B60H 1/00; F04D 29/70; F04D 29/58

(52) U.S. Cl. CPC B60H 3/0092; F04D 29/701; F04D 29/582; B60H 1/3233; B60H 1/00885; B60H 1/00828; B60H 1/3227; B60H 1/3207; B60H 1/12; B60H 2001/3245; B60H 2001/3266

(57) ABSTRACT

A system is for preventing molding on an evaporator associated with a vehicle air conditioning system for supplying conditioned air to a vehicle passenger cabin. The system includes a blower for selectively directing airflow over the evaporator and a controller for controlling the blower based on a sensed humidity adjacent the evaporator. The controller may also control a pump for circulating warm coolant from an engine cooling system to a heater core to warm the airflow directed to the evaporator by the blower, and thus contribute to the drying provided. Related methods are also disclosed.

### TECHNICAL FIELD

This document relates generally to the motor vehicle field and, more particularly, to a method and system for preventing vehicular molding and avoiding mold smell.

### BACKGROUND

Vehicle passengers sometimes encounter an unpleasant smell when turning on or off the air conditioning in a vehicle. This unpleasant smell can last for several seconds or minutes. The primary reason for the unpleasant smell is often mold build up on the evaporator. Specifically, as the air conditioner functions to deliver cabin cooling, the evaporator becomes cold and cools the water vapor in the ambient air around it. This causes a dew point effect in which the water vapor condenses into liquid and deposits onto the coil of the evaporator. Over time, this moisture becomes moldy and hence the cause for the bad smell, which can in severe cases cause irritation and breathing problems. Passengers may choose to open the windows and sacrifice cabin comfort until the bad smell goes away. It is possible to temporarily fix the bad smell issue by spraying a water/bleach mixture or anti mold spray onto the evaporator coil, but the mold will re-appear once the air conditioner is used again.

Thus, a need is identified for a method and system for preventing vehicular molding and avoiding mold smell.

### SUMMARY

According to one aspect of the disclosure, a system for preventing molding on an evaporator associated with a vehicle air conditioner for supplying conditioned air to a vehicle passenger cabin is provided. The system comprises a blower for selectively directing airflow over the evaporator. A controller is also provided for controlling the blower based on a sensed humidity adjacent the evaporator.

In one embodiment, the system includes a humidity sensor for providing the sensed humidity. The blower is arranged for directing the airflow to the evaporator via a duct including the humidity sensor. The controller may comprise a circuit for reversing a motor of the blower to direct the airflow to a location outside of the vehicle passenger cabin when a vehicle ignition is turned off.

The controller may be adapted to periodically control the blower for directing the airflow over the evaporator once a vehicle ignition is turned off. The controller may also be adapted to control the blower until the sensed humidity reaches a pre-determined value, such as at or near zero. This assures that the drying of the evaporator is achieved reliably, and the growth of mold is thus pre-emptively controlled.

In this or other embodiments, the blower is in communication with a heater for heating the airflow prior to being directed over the evaporator. The heater may comprise a heater core in communication with a vehicle engine cooling system. A pump is provided for circulating a heated fluid from the vehicle engine cooling system to the heater core when a vehicle ignition is turned off. The controller may be adapted for controlling the blower and the pump to operate concurrently.

According to a further aspect of the disclosure, a system for preventing molding on an evaporator associated with a vehicle air conditioner for supplying conditioned air to a vehicle passenger cabin is provided. The system comprises a blower for selectively directing airflow over the evaporator, a heater for heating the airflow directed over the evaporator by the blower, and a controller for controlling the blower and the heater.

In one embodiment, the heater comprises a heater core for receiving coolant from an engine cooling system by way of a pump. The controller is adapted for controlling the pump to deliver the coolant to the heater core when a vehicle ignition is turned off. The system may further include a humidity sensor for sensing a humidity level adjacent to the heater core. The controller may be adapted to operate the blower and the heater together until the humidity level reaches a pre-determined value.

According to a further aspect of the disclosure, a method for preventing molding on an evaporator for supplying conditioned air to a passenger cabin associated with a vehicle engine is provided. The method comprises delivering airflow over the evaporator until a humidity value adjacent the evaporator reaches a pre-determined value. The delivering step may comprise operating a blower for blowing air toward the passenger cabin in a normal mode of operation in a reverse mode to direct airflow to a location outside the passenger cabin when the vehicle engine is turned off. The method may further include the step of circulating fluid through a heater core while operating a blower for directing airflow heated by the heater core to the evaporator. The delivering step may be performed periodically or based on an amount of operating time for a vehicle air conditioning system.

According to yet another aspect of the disclosure, a method for preventing molding on an evaporator for supplying conditioned air to a passenger cabin of a vehicle including a cooling system for cooling an engine and associated with a heater core for heating the passenger cabin is provided. After turning off the vehicle engine, the method comprises delivering fluid to the heater core while operating a blower in reverse for directing airflow heated by the heater core across the evaporator. The delivering step may be performed periodically or based on a number of operating cycles of an air conditioning system associated with the vehicle. The circulating step may be completed until a pre-determined humidity level is present adjacent to the evaporator.

In the following description, several embodiments of the method and system for preventing vehicular molding and avoiding mold smell. are shown and described. As it should be realized, the arrangement is capable of other, different embodiments and its several details are capable of modification in various, obvious aspects all without departing from the method and system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the disclosed method and system for preventing molding and, together with the description, serve to explain certain principles thereof. In the drawing figures:

FIG. 1 is a schematic view of a vehicle air conditioning system in a regular mode of operation;

FIG. 2 is a schematic view of a vehicle air conditioning system implementing a cleaning cycle according to the disclosure; and

FIG. 3 is a schematic view illustrating a possible embodiment of a reversing circuit for a blower motor.

Reference will now be made in detail to the present preferred embodiments of the method and system for preventing molding, examples of which are illustrated in the accompanying drawing figures.

### DETAILED DESCRIPTION

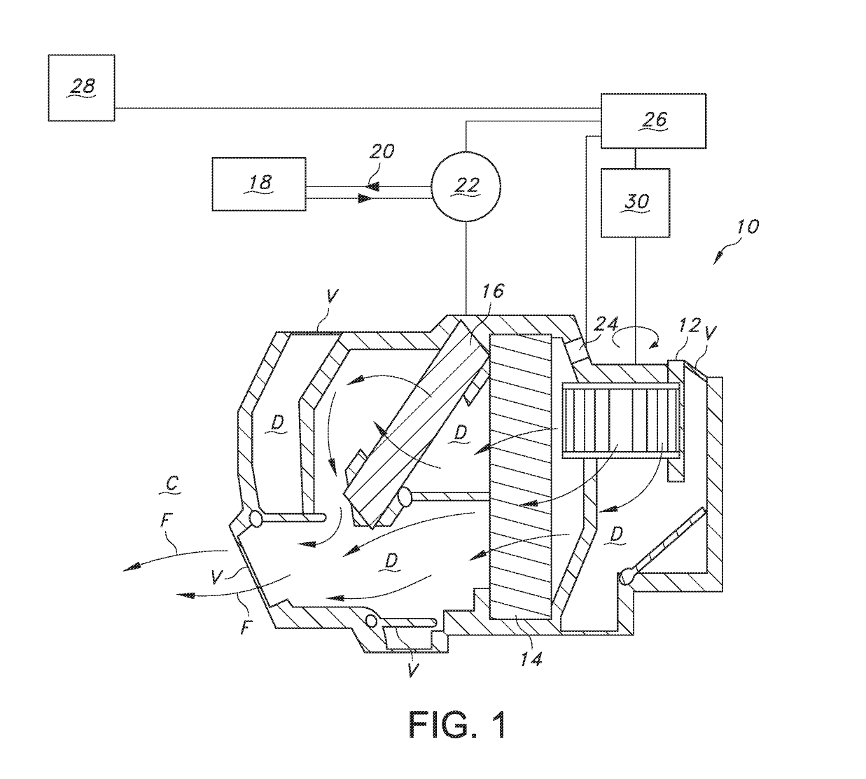

Reference is now made to FIG. 1, which schematically illustrates an exemplary air conditioner or air conditioning system 10 for a vehicle. As can be understood, the system 10 includes a blower 12 for drawing air from a location outside of a vehicle passenger cabin C to the passenger cabin to regulate the temperature thereof. The system 10 thus includes various ducts D and vents V for distributing the air in a desired manner, which can be controlled by the vehicle passengers using dashboard controls in the conventional manner.

In the typical arrangement, the blower 12 causes airflow to blow over a heat exchanger in the form of an evaporator 14 (sometimes also called an evaporator core) for cooling the water vapor in the airflow prior to delivery to the passenger cabin (note forward arrows F in FIG. 1, indicating flow in a first direction from outside of the vehicle to the passenger cabin C). Using suitable venting, heating of the air may also be achieved using a heater core 16, which as illustrated may receive warmed fluid (coolant) from an engine cooling system 18 via a circuit 20 including a pump 22. When the vehicle is turned off, the system 10 is usually shut down as well, which as noted above can lead to the presence of lingering moisture in the ducts and on components, such as the evaporator 14. This may contribute to the problem of molding and hence an unpleasant smell when the system is operated as described.

According to one aspect of the disclosure, the system 10 is adapted for avoiding the molding problem by using a sensed humidity value to determine whether to perform a cleaning cycle on the evaporator 14 to prevent the appearance or growth of mold. In the illustrated embodiment, this may be achieved by placing a humidity sensor 24 in a duct D adjacent to the evaporator 14, which sensor may communicate with a controller 26. While shown in the same compartment, the sensor 24 may be positioned at any place in the system 10 for sensing the humidity level in associated with the evaporator 14, which is thus indicative of conditions for mold growth.

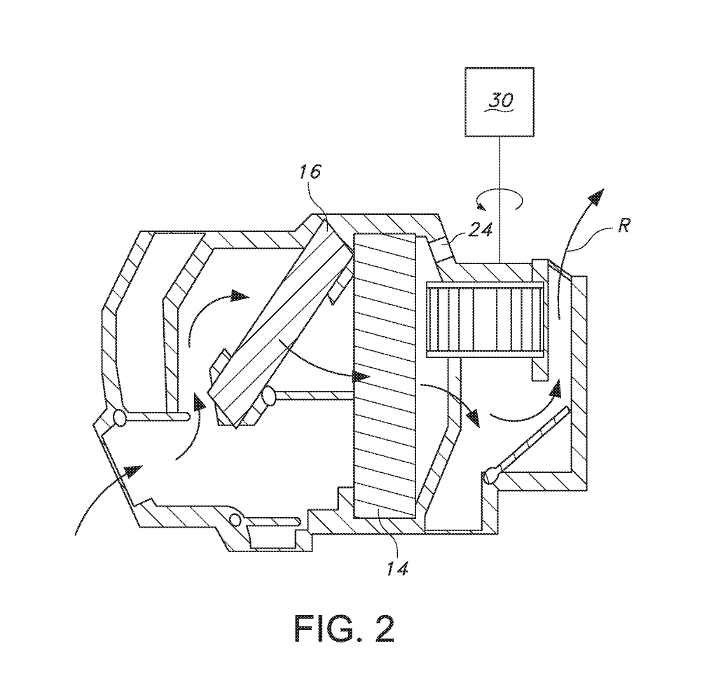

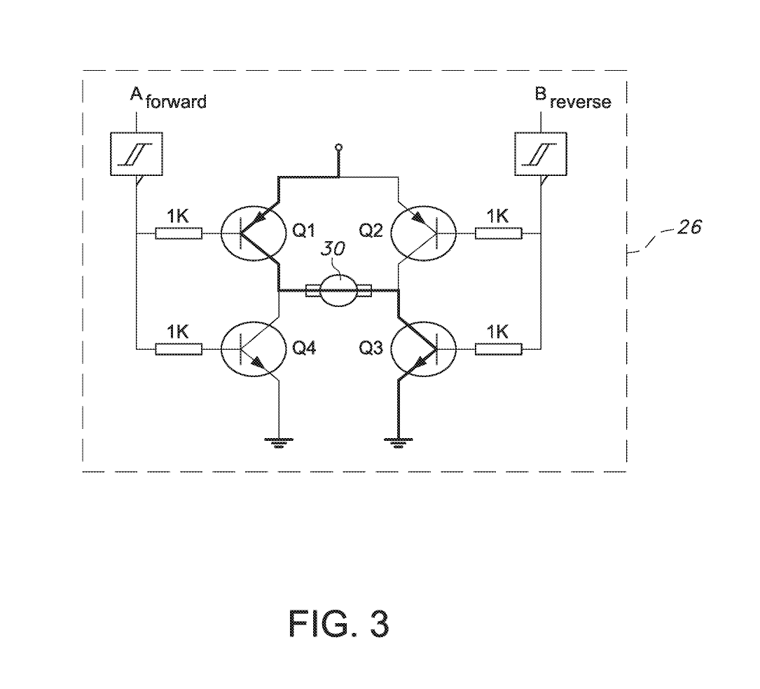

When a vehicle ignition 28 is turned off in a manner that would also normally shut off the air conditioning system 10, the controller 26 may cause a motor 30 associated with the blower 12 to operate in a reverse mode (such as by providing a reversing circuit, as shown in FIG. 3, in which transistors Q2 and Q4 are energized when the blower operates normally to deliver air to the passenger cabin, and transistors Q1 and Q3 are energized to reverse the motor 30 and cause the blower to operate in reverse). As indicated in FIG. 2, this operation of the blower 12 in the reverse mode causes airflow R to move in a direction opposite the normal direction and over the evaporator 14, and thus assist in drying it and preventing the growth of mold. This operation may be completed until the humidity sensed by the sensor 24 reaches a sensed value or level at or near zero, thus indicating that the dryness in the surrounding environment is such that mold growth is inhibited. The controller 26 may then simply stop the operation of the blower 12.

According to a further aspect of the disclosure, the cleaning cycle may also be enhanced by warming the airflow being delivered to the evaporator 14. In one embodiment, this is achieved by using leftover heat from the engine cooling system 18 to warm the air being drawn over the evaporator 14 by the reversing of the blower 12. Specifically, the controller 26 may cause the pump 22 (such as an electric water pump) to continue to move warmed coolant through the circuit 20, and thus to a heater core 16, once the ignition 28 is turned off. The airflow is thus warmed by the heater core 16 as it is exhausted by the blower 12 operating in reverse, thus contributing to the drying of the evaporator 14 and the desired mold inhibition. The heater core 16 thus serves as a heater for the air delivered to the evaporator 14 by blower 12. Again, the pumping may simply be halted by the controller 26 along with the blower 12 once a pre-determined level of humidity is achieved, as sensed by the sensor 24.

As can be appreciated, the foregoing manner of drying the evaporator 14 and thus inhibiting mold growth can be done without at all impacting the comfort of the vehicle passengers, since it may be completed when the vehicle ignition is turned off and without at all involving the passenger cabin. In particular, the system 10 may be operated only once the vehicle cabin is unoccupied, which could be confirmed using a detector, such as a camera or other form of occupant detection system. The system 10 may also be activated to open or close the vehicle window to allow for proper venting to occur, including possibly by confirming that it is not raining and conditions are otherwise safe for doing so (e.g. the vehicle is at a home or known location, as determined by a location detector).

The operation of the cleaning cycle may also be initiated at the direction of a person, such as by issuing a command to the controller 26 in the vehicle when a mold smell is detected (such as by way of a button, or a menu item on a scroll-down menu on vehicle display or mobile device, or perhaps even by using a key fob), or based on a schedule. For instance, the controller 26 may be programmed to automatically cause the drying operation to be completed on the next ignition off after a particular number of cycles of the air conditioning system 10. The cleaning cycle may be performed until a desired humidity level is reached, as determined by the sensor 24 in communication with the controller 26, or may be completed for a pre-determined amount of time determined to be sufficient for drying the evaporator 14.

The system 10 may also be made to operate in an intelligent manner. For instance, using the humidity sensing feature, the system 10 via controller 26 may monitor the humidity adjacent to the evaporator 14 on a periodic basis, such as during each cleaning cycle or after a particular number of cycles. If it determined that the humidity level is not decreasing after a cleaning cycle, or is increasing over time despite similar ambient conditions (which may be determined by other sensors on the vehicle, such as by assessing the relative humidity external to the vehicle and comparing it with the sensed humidity), then the controller 26 may indicate to the operator that mold may be present, and that additional measures should be taken to perform a manual cleaning operation.

In summary, a method and system 10 for inhibiting molding is provided. When a vehicle ignition 28 is turned off or the engine otherwise halted, the system 10 may operate an existing blower 12 in reverse to dry the evaporator 14 until a pre-determined level of humidity is reached, preferably at or near zero. Warm engine coolant resulting from the running of the vehicle may also be continuously pumped to the heater core 16 during the reverse operation of the blower 12 to heat the airflow and thus contribute to the drying. The incidence of molding is thus pre-empted using the system 10 and related methods, and thus a more pleasant driving experience is achieved without any significant added cost or complexity.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A system for preventing molding on an evaporator associated with a vehicle air conditioner for supplying conditioned air to a vehicle passenger cabin, comprising:
a blower for selectively directing airflow over the evaporator; and
a controller for controlling the blower based on a sensed humidity adjacent the evaporator.

2. The system of claim 1, further including a humidity sensor for providing the sensed humidity.

3. The system of claim 2, wherein the blower is arranged to direct the airflow over the evaporator through a duct including the humidity sensor.

4. The system of claim 1, wherein the controller comprises a circuit for reversing a motor of the blower to direct the airflow to a location outside of the vehicle passenger cabin when a vehicle ignition is turned off.

5. The system of claim 1, wherein the controller is adapted to periodically control the blower for directing the airflow over the evaporator once a vehicle ignition is turned off.

6. The system of claim 1, wherein the controller is adapted to control the blower until the sensed humidity reaches a pre-determined value.

7. The system of claim 1, wherein the blower is in communication with a heater for heating the airflow prior to being directed over the evaporator.

8. The system of claim 7, wherein the heater comprises a heater core in communication with a vehicle engine cooling system, and further including a pump for circulating a heated fluid from the vehicle engine cooling system to the heater core when a vehicle ignition is turned off.

9. The system of claim 8, wherein the controller is adapted for controlling the blower and the pump to operate concurrently.

10. A system for preventing molding on an evaporator associated with a vehicle air conditioner for supplying conditioned air to a vehicle passenger cabin, comprising:
a blower for selectively directing airflow over the evaporator;
a heater for heating the airflow directed over the evaporator by the blower; and
a controller for controlling the blower and the heater.

11. The system of claim 10, wherein the heater comprises a heater core for receiving coolant from an engine cooling system by way of a pump and the controller is adapted for controlling the pump to deliver coolant to the heater core when a vehicle ignition is turned off.

12. The system of claim 10, further including a humidity sensor for sensing a humidity level adjacent to the heater, and wherein the controller is adapted to operate the blower and the heater until the humidity level reaches a pre-determined value.

13. The system of claim 10, wherein the controller comprises a circuit for reversing a motor of the blower to direct the airflow to a location outside of the vehicle passenger cabin when a vehicle ignition is turned off.

14. A method for preventing molding on an evaporator for supplying conditioned air to a passenger cabin associated with a vehicle engine, comprising:
delivering airflow over the evaporator until a humidity adjacent the evaporator reaches a pre-determined value.

15. The method of claim 14, wherein the delivering step comprises operating a blower for blowing air toward the passenger cabin in a normal mode of operation in a reverse mode to direct airflow to a location outside the passenger cabin when the vehicle engine is turned off.

16. The method of claim 14, further including the step of circulating fluid through a heater core while operating a blower for directing airflow heated by the heater core to the evaporator.

17. The method of claim 14, wherein the delivering step is performed periodically or based on an amount of operating time for a vehicle air conditioning system.

18. A method for preventing molding on an evaporator for supplying conditioned air to a passenger cabin of a vehicle including a cooling system using a fluid for cooling an engine and associated with a heater core for heating the passenger cabin, comprising:
after turning off the engine, delivering the fluid from the cooling system to the heater core while operating a blower in reverse for directing airflow heated by the heater core across the evaporator.

19. The method of claim 18, wherein the delivering and operating steps are performed periodically or based on a number of operating cycles of an air conditioning system associated with the vehicle.

20. The method of claim 18, wherein the delivering and operating steps are completed until a pre-determined humidity level is present adjacent to the evaporator.
